(19) United States
(12) Patent Application Publication
(10) Pub. No.: US 2017/0005601 A1
(43) Pub. Date: Jan. 5, 2017

(54) FAN DETECTION AND CONTROL CIRCUIT AND ELECTRONIC DEVICE HAVING THE SAME

(71) Applicants: HONG FU JIN PRECISION INDUSTRY (Shenzhen) CO., LTD, Shenzhen (CN); HON HAI PRECISION INDUSTRY CO., LTD, New Taipei (TW)

(72) Inventor: MENG-LIANG YANG, Shenzhen (CN)

(73) Assignee: HON HAI PRECISION INDUSTRY CO., LTD., New Taipei (TW)

(21) Appl. No.: 14/806,217

(22) Filed: Jul. 22, 2015

(30) Foreign Application Priority Data
Jul. 2, 2015 (CN) 201510380177.3

(51) Int. Cl. H02P 6/12; H02P 21/00

(52) U.S. Cl. CPC H02P 6/12; H02P 21/0003

(57) ABSTRACT

A fan detection and control circuit for a storage device includes an extension chip configured to output a control signal, a plurality of transmission units, a plurality of control units and a fan detection and control chip electrically coupled to the extension chip, the transmission units and the control units. Each transmission unit corresponds to a fan. Each control unit is electrically coupled to a transmission unit from amongst the plurality of transmission units. The fan detection and control chip receives the control signal and outputs a pulse signal and a detection signal via the transmission units and the control units. When the fan is connected to the corresponding transmission unit and operating normally, the fan detection and control chip outputs a first type detection signal to the corresponding control unit, and the control unit outputs a first state signal to indicate the fan is operating normally.

### FIELD

The subject matter herein generally relates to an electronic device with a fan detection and control circuit.

### BACKGROUND

A number of hard disks can be mounted in a just a bunch disks (JBOD) system; a number of fans are needed to dissipate heat from the JBOD system. When the fans are operating, the speed of the fans needs to be controlled, and the fans need to be tested if operating normally.

### BRIEF DESCRIPTION OF THE DRAWING

Implementations of the present technology will now be described, by way of example only, with reference to the attached figures.

FIG. 1 is a block diagram of an embodiment of an electronic device, the electronic device comprising a fan detection and control circuit.

FIG. 2 is a block diagram of an embodiment of the fan detection and control circuit of FIG. 1.

FIG. 3 is a circuit diagram of an embodiment of the fan detection and control circuit of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein.

However, it will be understood by those of ordinary skill in the art that the embodiments described herein can be practiced without these specific details. In other instances, methods, procedures, and components have not been described in detail so as not to obscure the related relevant feature being described. The drawing is not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections.

The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure relates to an electronic device with a fan detection and control circuit.

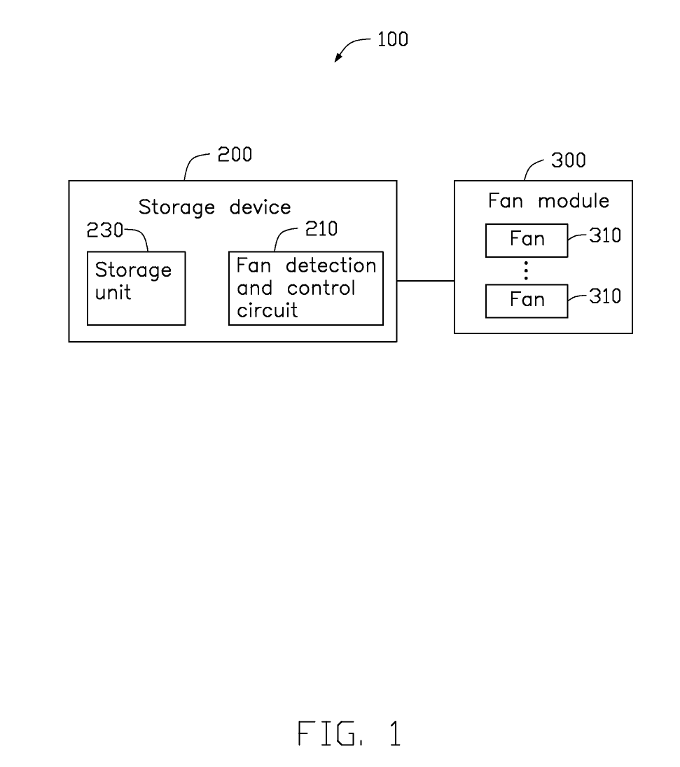

FIG. 1 illustrates an embodiment of an electronic device 100. The electronic device 100 can comprise a storage device 200 and a fan module 300. The storage device 200 can comprise a fan detection and control circuit 210 and a plurality of storage units 230.

The fan module 300 can comprise a plurality of fans 310, which are coupled to dissipate heat from the storage units 230 of the storage device 200. The fan detection and control circuit 210 is electrically coupled to the fan module 300, to control the speed of the fans 310 and detect whether the fans 310 are connected to the electronic device 100 and whether the fans 310 are operating normally.

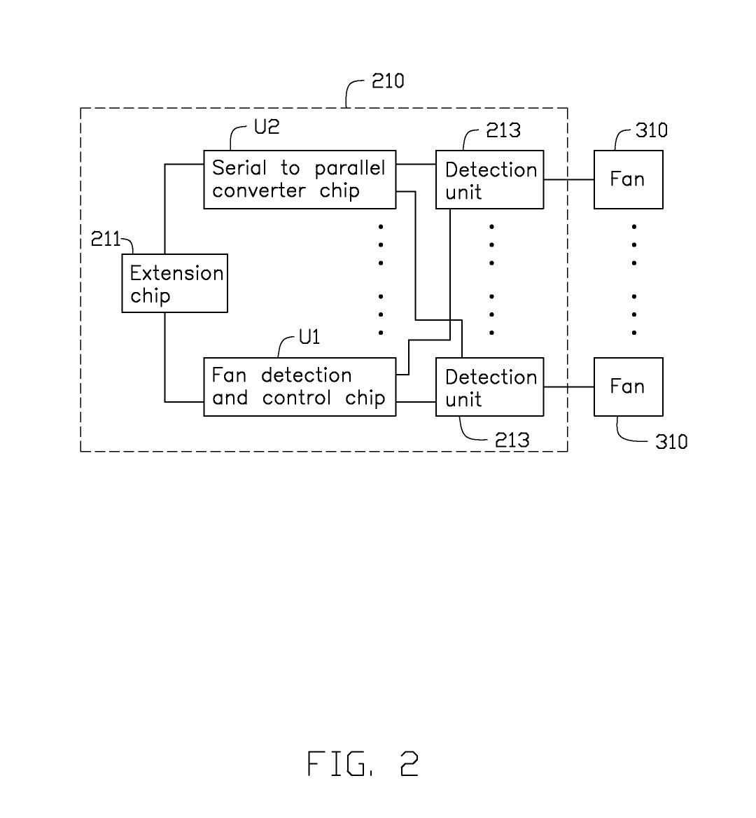

FIG. 2 illustrates a block diagram of the fan detection and control circuit 210. The fan detection and control circuit 210 can comprise an extension chip 211, a fan detection and control chip U1, a plurality of detection units 213, and a serial to parallel converter chip U2. Each one of the detection units 213 from amongst the plurality of detection units 213 is electrically coupled to a fan 310 of the fan module 300.

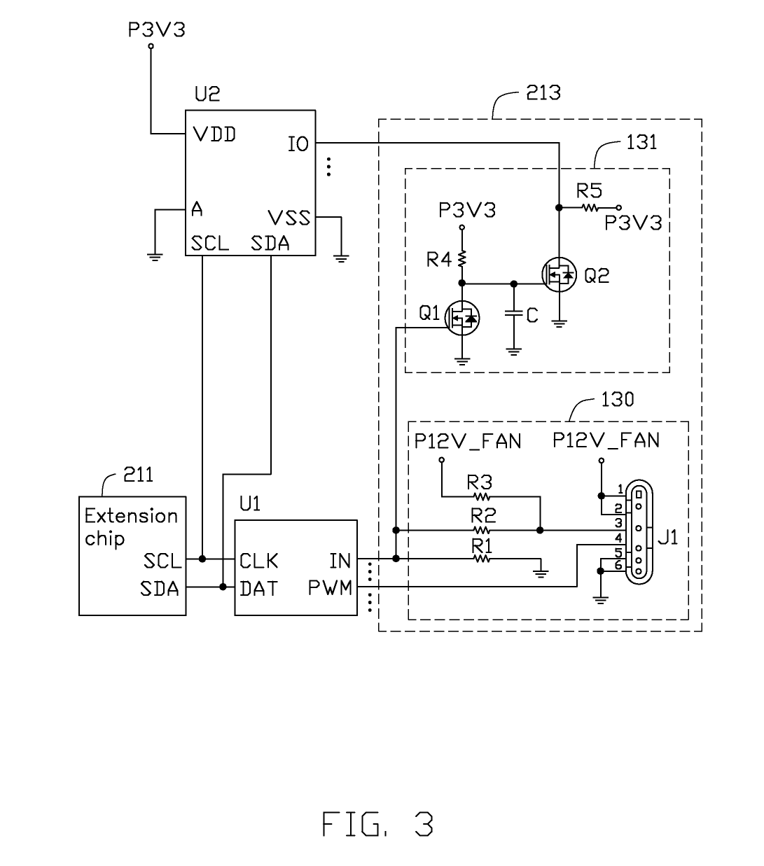

FIG. 3 illustrates a circuit diagram of the fan detection and control circuit 210. The extension chip 211 can comprise a clock signal pin SCL and a data signal pin SDA. The fan detection and control chip U1 can comprise a clock signal pin CLK, a data signal pin DAT, a plurality of detection pins IN, and a plurality of pulse pins PWM. The extension chip 211 is electrically coupled to the fan detection and control chip U1 through an Inter-Integrated Circuit (I2C) bus. The clock signal pin SCL of the extension chip 211 is electrically coupled to the clock signal pin CLK of the fan detection and control chip U1, and the data signal pin SDA of the extension chip 211 is electrically coupled to the data signal pin DAT of the fan detection and control chip U1.

Each of the detection units 213 can comprise a transmission unit 130 and a control unit 131. The transmission unit 130 can comprise a fan connector J1 and three resistors R1-R3. The control unit 131 can comprise two electronic switches Q1 and Q2, a capacitor C and two resistors R4 and R5. The fan connector J1 can comprise six pins 1-6. The detection pin IN of the fan detection and control chip U1 is electrically coupled to the pin 3 of the fan connector J1 through the resistor R2, and electrically coupled to ground through the resistor R1. The detection pin IN of the fan detection and control chip U1 is further electrically coupled to the control unit 131, and is electrically coupled to a power supply Pl2V FAN successively through the resistors R2 and R3. The pulse pin PWM of the fan detection and control chip U1 is electrically coupled to the pin 4 of the fan connector J1. The pins 1 and 2 of the fan connector J1 are electrically coupled to the power supply Pl2V FAN. The pin 3 of the fan connector J1 is electrically coupled to the control unit 131 through the resistor R2. The pins 5 and 6 of the fan connector J1 are electrically coupled to ground. A first terminal of the electronic switch Q1 is electrically coupled to the detection pin IN. A second terminal of the electronic switch Q1 is electrically coupled to a first terminal of the electronic switch Q2, and is electrically coupled to a power supply P3V3 through the resistor R4. The second terminal of the electronic switch Q1 is further electrically coupled to ground through the capacitor C. A third terminal of the electronic switch Q1 is electrically coupled to ground. A second terminal of the electronic switch Q2 is electrically coupled to the serial to parallel converter chip U2, and is electrically coupled to the power supply P3V3 through the resistor R5. A third terminal of the electronic switch Q2 is electrically coupled to ground. In at least one embodiment, each of the detection units 213 is electrically coupled to a corresponding detection pin IN and a corresponding pulse pin PWM of the fan detection and control chip U1, and the fan connector J1 of each detection unit 213 is electrically coupled to a corresponding fan 310 of the fan module 300.

The serial to parallel converter chip U2 can comprise a plurality of input pins IO, a clock signal pin SCL, a data signal pin SDA, a power supply pin VDD, and two ground pins A and VSS. Each of the input pins IO is electrically coupled to the second terminal of the electronic switch Q2 of the corresponding detection unit 213. The serial to parallel converter chip U2 is electrically coupled to the extension chip 211 through the I2C bus. The clock signal pin SCL of the serial to parallel converter chip U2 is electrically coupled to the clock signal pin SCL of the extension chip 211, and the data signal pin SDA of the serial to parallel converter chip U2 is electrically coupled to the data signal pin SDA of the extension chip 211. The power supply pin VDD of the serial to parallel converter chip U2 is electrically coupled to the power supply P3V3, and the ground pins A and VSS of the serial to parallel converter chip U2 are electrically coupled to ground.

In at least one embodiment, each of the electronic switches Q1 and Q2 can be n-channel metal-oxide semiconductor field-effect transistors (NMOSFET), and the first terminal, the second terminal, and the third terminal of each of the electronic switches Q1 and Q2 correspond to a gate, a drain, and a source of the NMOSFET.

When the storage units 230 are operating, the fan module 300 dissipates heat from the storage units 230. The extension chip 211 outputs a control signal to the fan detection and control chip U1 through the I2C bus, and each pulse pin PWM of the fan detection and control chip U1 outputs a PWM signal to the fan connector J1 of the corresponding detection unit 213. The pin 4 of the fan connector J1 outputs the PWM signal to the corresponding fan 310, to control the speed of the fan 310.

When the fan 310 is connected to the fan connector J1 of the corresponding detection unit 213 and operates normally, the detection pin IN of the fan detection and control chip U1 outputs a first detection signal to the first terminal of the electronic switch Q1, and the first detection signal is a square wave signal. When the first detection signal is a low level signal, the electronic switch Q1 is turned off. The power supply P3V3 outputs a voltage to turn on the electronic switch Q2 through adjusting resistance of the resistor R4, and the voltage filtered by the capacitor C is output to the first terminal of the electronic switch Q2. The electronic switch Q2 is turned on, and the second terminal of the electronic switch Q2 outputs a low level signal to the corresponding input pin IO of the serial to parallel converter chip U2. The serial to parallel converter chip U2 outputs the low level signal to the extension chip 211 through the I2C bus, and the extension chip 211 detects that the fans 310 are connected to the corresponding fan connector J1. When the first detection signal is a high level signal, the electronic switch Q1 is turned on, and the electronic switch Q2 is turned off. The corresponding input pin IO of the serial to parallel converter chip U2 receives a high level signal and transports the high level signal to the extension chip 211 through the I2C bus. Therefore, when the extension chip 211 receives an alternating high and low logic signal, the fan 310 is connected to the fan connector J1 of the corresponding detection unit 213 and operating normally.

When the fan 310 is connected to the fan connector J1 of the corresponding detection unit 213 and operating abnormally, the detection pin IN of the fan detection and control chip U1 outputs a second detection signal to the first terminal of the electronic switch Q1, and the second detection signal is a low level signal. The electronic switch Q1 is turned off, and the first terminal of the electronic switch Q2 receives a high level signal from the power supply P3V3 through the resistor R4. The electronic switch Q2 is turned on, and the second terminal of the electronic switch Q2 outputs a low level signal to the corresponding input pin IO of the serial to parallel converter chip U2. The serial to parallel converter chip U2 outputs the low level signal to the extension chip 211 through the I2C bus. Therefore, when the extension chip 211 receives the continuous low level signal, the fan 310 is connected to the fan connector J1 of the corresponding detection unit 213 and operating abnormally.

When the fan 310 is not connected to the fan connector J1 of the corresponding detection unit 213, the first terminal of the electronic switch Q1 receives a high level signal from the power supply P 12V FAN through the resistors R2 and R3, and the electronic switch Q1 is turned on. The second terminal of the electronic switch Q1 outputs a low level signal to the first terminal of the electronic switch Q2, and the electronic switch Q2 is turned off. The corresponding input pin IO of the serial to parallel converter chip U2 receives a high level signal and transmits the high level signal to the extension chip 211 through the I2C bus. Therefore, when the extension chip 211 receives the continuous high level signal, the fan 310 is not connected to the fan connector J1 of the corresponding detection unit 213.

The embodiments shown and described above are only examples. Even though numerous characteristics and advantages of the present technology have been set forth in the foregoing description, together with details of the structure and function of the present disclosure, the disclosure is illustrative only, and changes may be made in the details, including matters of shape, size, and arrangement of the parts within the principles of the present disclosure, up to and including the full extent established by the broad general meaning of the terms used in the claims.

What is claimed is:

1. A fan detection and control circuit for a storage device, the fan detection and control circuit comprising:
an extension chip configured to output a control signal;
a plurality of transmission units, each one of the transmission units from amongst the plurality of transmission units configured to couple to a fan from amongst a plurality of fans;
a plurality of control units, each one of the control units from amongst the plurality of control units electrically coupled to a transmission unit from amongst the plurality of transmission units; and
a fan detection and control chip electrically coupled to the extension chip, the transmission units, and the control units, the fan detection and control chip configured to receive the control signal from the extension chip and output a pulse signal and a detection signal via the transmission units and the control units;
wherein in event that a fan is connected to a transmission unit from amongst the plurality of transmission units and operates normally, the fan detection and control chip outputs a first type detection signal to the control unit which corresponds to the transmission unit to which the fan is connected, and the control unit outputs a first state signal indicating that the fan is operating normally.

2. The fan detection and control circuit of claim 1, wherein the fan detection and control circuit further comprises a serial to parallel converter chip electrically coupled to the extension chip and each control unit, to configure to transmit the first state signal from the control unit to the extension chip.

3. The fan detection and control circuit of claim 2, wherein the extension chip comprises a clock signal pin and a data signal pin, the fan detection and control chip comprises a clock signal pin, a data signal pin, a plurality of detection pins and a plurality of pulse pins, the extension chip is electrically coupled to the fan detection and control chip through an Inter-Integrated Circuit (I2C) bus, the clock signal pin of the extension chip is electrically coupled to the clock signal pin of the fan detection and control chip, the data signal pin of the extension chip is electrically coupled to the data signal pin of the fan detection and control chip, each of the detection pins of the fan detection and control chip is electrically coupled to a corresponding transmission unit and control unit to output the detection signal, and each of the pulse pins of the fan detection and control chip is electrically coupled to a transmission unit from amongst the plurality of transmission units, to configure to output the pulse signal and control speed of the corresponding fan electrically coupled to the corresponding transmission unit.

4. The fan detection and control circuit of claim 3, wherein each of the transmission units comprises a fan connector, a first resistor, a second resistor and a third resistor, the fan connector comprises a first pin, a second pin, a third pin and a fourth pin, the detection pin of the fan detection and control chip is electrically coupled to the second pin of the fan connector through the second resistor and electrically coupled to ground through the first resistor, the detection pin of the fan detection and control chip is further electrically coupled to the control unit and electrically coupled to a power supply successively through the second resistor and the third resistor, the pulse pin of the fan detection and control chip is electrically coupled to the third pin of the fan connector, the first pin of the fan connector is electrically coupled to the power supply, the third pin of the fan connector is electrically coupled to the control unit through the second resistor, and the fourth pin of the fan connector is electrically coupled to ground.

5. The fan detection and control circuit of claim 4, wherein each of the control units comprises a first electronic switch, a second electronic switch, a fourth resistor, a fifth resistor and a capacitor, a first terminal of the first electronic switch is electrically coupled to the corresponding detection pin of the fan detection and control chip, a second terminal of the first electronic switch is electrically coupled to a first terminal of the second electronic switch and electrically coupled to the power supply through the fourth resistor, the second terminal of the first electronic switch is further electrically coupled to ground through the capacitor, a third terminal of the first electronic switch is electrically coupled to ground, a second terminal of the second electronic switch is electrically coupled to the serial to parallel converter chip and electrically coupled to the power supply through the fifth resistor, and a third terminal of the second electronic switch is electrically coupled to ground.

6. The fan detection and control circuit of claim 5, wherein when the fan is connected to the corresponding fan connector and operating normally, the detection pin of the fan detection and control chip outputs the first type detection signal to the first electronic switch of the control unit, in event that the first type detection signal is a low level signal, the first electronic switch is turned off, the second electronic switch is turned on, the second terminal of the second electronic switch outputs the low level signal to the serial to parallel converter chip, in event that the first type detection signal is a high level signal, the first electronic switch is turned on, the second electronic switch is turned off, the second electronic switch outputs the high level signal to the serial to parallel converter chip, and the serial to parallel converter chip transmits an alternating high and low logic signal to the extension chip.

7. The fan detection and control circuit of claim 6, wherein when the fan is connected to the corresponding fan connector and operating abnormally, the detection pin of the fan detection and control chip outputs a second type detection signal to the first electronic switch of the control unit, the first electronic switch is turned off, the second electronic switch is turned on, and the second electronic switch outputs the low level signal to the serial to parallel converter chip.

8. The fan detection and control circuit of claim 7, wherein when the fan is not connected to the corresponding fan connector, the detection pin of the fan detection and control chip outputs a third type detection signal to the first electronic switch of the control unit, the first electronic switch is turned on, the second electronic switch is turned off, and the second electronic switch outputs the high level signal to the serial to parallel converter chip.

9. The fan detection and control circuit of claim 5, wherein the serial to parallel converter chip comprises a plurality of input pins, a clock signal pin, a data signal pin, a power supply pin and a ground pin, each of the input pins is electrically coupled to the second terminal of the second electronic switch of the corresponding control unit, the serial to parallel converter chip is electrically coupled to the extension chip through the I2C bus, the clock signal pin of the serial to parallel converter chip is electrically coupled to the clock signal pin of the extension chip, the data signal pin of the serial to parallel converter chip is electrically coupled to the data signal pin of the extension chip, the power supply pin of the serial to parallel converter chip is electrically coupled to the power supply, the ground pin of the serial to parallel converter chip is electrically coupled to ground, and the serial to parallel converter chip outputs the high level signal or low level signal to the extension chip.

10. The fan detection and control circuit of claim 5, wherein the first and second electronic switches are all n-channel metal-oxide semiconductor field-effect transistors (NMOSFET), the first terminal, the second terminal and the third terminal of the first and second electronic switches correspond to a gate, a drain, and a source of the n-channel metal-oxide semiconductor field-effect transistors.

11. An electronic device comprising:
a fan module comprising a plurality of fans; and
a fan detection and control circuit for a storage device, the fan detection and control circuit comprising:
an extension chip configured to output a control signal;
a plurality of transmission units, each one of the transmission units from amongst the plurality of transmission units configured to couple to a fan from amongst the plurality of fans;
a plurality of control units, each one of the control units from amongst the plurality of control units electrically coupled to a transmission unit from amongst the plurality of transmission units; and
a fan detection and control chip electrically coupled to the extension chip, the transmission units, and the control units, the fan detection and control chip configured to receive the control signal from the extension chip and output a pulse signal and a detection signal via the transmission units and the control units;
wherein in event that a fan is connected to a transmission unit from amongst the plurality of transmission units and operates normally, the fan detection and control chip outputs a first type detection signal to the control unit which corresponds to the transmission unit to which the fan is connected, and the control unit outputs a first state signal indicating that the fan is operating normally.

12. The electronic device of claim 11, wherein the fan detection and control circuit further comprises a serial to parallel converter chip electrically coupled to the extension chip and each control unit, to configure to transmit the first state signal from the control unit to the extension chip.

13. The electronic device d of claim 12, wherein the extension chip comprises a clock signal pin and a data signal pin, the fan detection and control chip comprises a clock signal pin, a data signal pin, a plurality of detection pins and a plurality of pulse pins, the extension chip is electrically coupled to the fan detection and control chip through an Inter-Integrated Circuit (I2C) bus, the clock signal pin of the extension chip is electrically coupled to the clock signal pin of the fan detection and control chip, the data signal pin of the extension chip is electrically coupled to the data signal pin of the fan detection and control chip, each of the detection pins of the fan detection and control chip is electrically coupled to a corresponding transmission unit and control unit to output the detection signal, and each of the pulse pins of the fan detection and control chip is electrically coupled to a transmission unit from amongst the plurality of transmission units, to configure to output the pulse signal and control speed of the corresponding fan electrically coupled to the corresponding transmission unit.

14. The electronic device of claim 13, wherein each of the transmission units comprises a fan connector, a first resistor, a second resistor and a third resistor, the fan connector comprises a first pin, a second pin, a third pin and a fourth pin, the detection pin of the fan detection and control chip is electrically coupled to the second pin of the fan connector through the second resistor and electrically coupled to ground through the first resistor, the detection pin of the fan detection and control chip is further electrically coupled to the control unit and electrically coupled to a power supply successively through the second resistor and the third resistor, the pulse pin of the fan detection and control chip is electrically coupled to the third pin of the fan connector, the first pin of the fan connector is electrically coupled to the power supply, the third pin of the fan connector is electrically coupled to the control unit through the second resistor, and the fourth pin of the fan connector is electrically coupled to ground.

15. The electronic device of claim 14, wherein each of the control units comprises a first electronic switch, a second electronic switch, a fourth resistor, a fifth resistor and a capacitor, a first terminal of the first electronic switch is electrically coupled to the corresponding detection pin of the fan detection and control chip, a second terminal of the first electronic switch is electrically coupled to a first terminal of the second electronic switch and electrically coupled to the power supply through the fourth resistor, the second terminal of the first electronic switch is further electrically coupled to ground through the capacitor, a third terminal of the first electronic switch is electrically coupled to ground, a second terminal of the second electronic switch is electrically coupled to the serial to parallel converter chip and electrically coupled to the power supply through the fifth resistor, and a third terminal of the second electronic switch is electrically coupled to ground.

16. The electronic device of claim 15, wherein when the fan is connected to the corresponding fan connector and operating normally, the detection pin of the fan detection and control chip outputs the first type detection signal to the first electronic switch of the control unit, in event that the first type detection signal is a low level signal, the first electronic switch is turned off, the second electronic switch is turned on, the second terminal of the second electronic switch outputs the low level signal to the serial to parallel converter chip, in event that the first type detection signal is a high level signal, the first electronic switch is turned on, the second electronic switch is turned off, the second electronic switch outputs the high level signal to the serial to parallel converter chip, and the serial to parallel converter chip transmits an alternating high and low logic signal to the extension chip.

17. The electronic device of claim 16, wherein when the fan is connected to the corresponding fan connector and operating abnormally, the detection pin of the fan detection and control chip outputs a second type detection signal to the first electronic switch of the control unit, the first electronic switch is turned off, the second electronic switch is turned on, and the second electronic switch outputs the low level signal to the serial to parallel converter chip.

18. The electronic device of claim 17, wherein when the fan is not connected to the corresponding fan connector, the detection pin of the fan detection and control chip outputs a third type detection signal to the first electronic switch of the control unit, the first electronic switch is turned on, the second electronic switch is turned off, and the second electronic switch outputs the high level signal to the serial to parallel converter chip.

19. The electronic device of claim 15, wherein the serial to parallel converter chip comprises a plurality of input pins, a clock signal pin, a data signal pin, a power supply pin and a ground pin, each of the input pins is electrically coupled to the second terminal of the second electronic switch of the corresponding control unit, the serial to parallel converter chip is electrically coupled to the extension chip through the I2C bus, the clock signal pin of the serial to parallel converter chip is electrically coupled to the clock signal pin of the extension chip, the data signal pin of the serial to parallel converter chip is electrically coupled to the data signal pin of the extension chip, the power supply pin of the serial to parallel converter chip is electrically coupled to the power supply, the ground pin of the serial to parallel converter chip is electrically coupled to ground, and the serial to parallel converter chip outputs the high level signal or low level signal to the extension chip.

20. The electronic device of claim 15, wherein the first and second electronic switches are all n-channel metal-oxide semiconductor field-effect transistors (NMOSFET), the first terminal, the second terminal and the third terminal of the first and second electronic switches correspond to a gate, a drain, and a source of the n-channel metal-oxide semiconductor field-effect transistors.
